(19) United States
(12) Patent Application Publication
(10) Pub. No.: US 2003/0205482 A1
(43) Pub. Date: Nov. 6, 2003

(54) Method and apparatus for generating hydrogen and oxygen

(76) Inventor: Larry D. Allen, Renton, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/424,221

(22) Filed: Apr. 25, 2003

Related U.S. Application Data
(60) Provisional application No. 60/377,456, filed on May 2, 2002.

(51) Int. Cl. C02F 1/461; C25D 17/00

(52) U.S. Cl. 205/630; 204/270; 204/278; 205/635; 205/638

(57) ABSTRACT

A hydrogen and oxygen gas generator (100) is provided that uses electrodes (160) made of carbon graphite and disposed in a vessel (110) containing a conductive solution of water and salt (165). The carbon graphite electrodes may be made of graphite baked with a binder to form rods, and may include a conductive cladding over a portion of the rods. An electric potential is applied between the electrodes, causing a current through the saline solution that results in dissociation of water into hydrogen and oxygen, which is expelled through a gas discharge port (156) in the vessel. The generator may be used as a stand-alone combustible gas generator, or in a vehicle (90), powered by an alternator (96) driven by the vehicle engine (98), and providing hydrogen and oxygen to the engine to improve the efficiency of the engine.

### CROSS-REFERENCE TO RELATED APPLICATION

This application claims the benefit of Provisional Application No. 60/377,456, filed May 2, 2002, the benefit of which is hereby claimed under 35 U.S.C. § 119, and the disclosure of which is hereby incorporated by reference.

### FIELD OF THE INVENTION

The present invention relates to methods and devices for generating hydrogen and oxygen gases from water.

### BACKGROUND OF THE INVENTION

Devices and apparatuses for generating combustible gas mixtures from water—such as hydrogen and oxygen gas mixtures—are known in the art. Such devices have many potential uses. Hydrogen burns very efficiently and, under ideal circumstances, produces only water during the combustion process. Moreover, it is known that the addition of relatively small quantities of hydrogen and oxygen to the fuel-air mixture in an internal combustion engine can improve the efficiency of the engine and obtain a cleaner burn of the fuel, thereby improving overall engine performance while reducing emissions.

However, hydrogen and oxygen are highly volatile, and can be explosive under certain conditions. Storing and/or transporting quantities of hydrogen can therefore raise significant safety concerns. Moreover, hydrogen is difficult to store in its gaseous or liquid state because it can flow through cracks that may not be visible to the naked eye. Due in part to the difficulties and risks associated with storing and transporting hydrogen oxygen, neither hydrogen powered engines nor hydrogen augmented internal combustion gasoline engines have found wide spread acceptance in the consumer market.

It is also known, however, that hydrogen and oxygen can be produced by the passage of a current between spaced electrodes through an electrolytic solution of certain acids or bases (called electrolytes) that are dissolved in water. This process is called electrolysis. In conventional electrolysis, metal anodes and cathodes, usually in parallel plates, are immersed in the electrolytic solution. A disadvantage of prior art electrolysis systems is that the electrolyte chemically decomposes by the passage of the current through the solution and the anodes (and sometimes the cathodes) corrode relatively rapidly, requiring frequent replacement. An electrolysis apparatus for producing hydrogen and oxygen is disclosed, for example, in U.S. Pat. No. 1,597,553, to Stuart. As discussed by Stuart, one of the great obstacles in this type of electrolysis is the corrosion of the metal electrodes used therein. Stuart discloses an apparatus that mitigates the metal electrode corrosion problem by providing a very large electrode surface area and operating at low voltages. Such a system, however, requires very long electrode elements that are expensive to produce, and may be prone to shorting out if oppositely charged electrodes touch each other.

It has been proposed that hydrogen and oxygen may be produced on demand for internal combustion engines to provide hydrogen and oxygen to the fuel-air mixture in an internal combustion engine, to improve the engine overall performance. Although it requires a significant amount of energy to disassociate water into hydrogen gas and oxygen gas, providing appropriate quantities of hydrogen and oxygen gases to a gasoline powered internal combustion engine can improve the efficiency of the engine fuel and, in particular, can increase the engine power output by more than the amount required to produce the hydrogen and oxygen. However, prior art systems for generating hydrogen and oxygen utilize metal electrodes that are sacrificially consumed during the electrolysis process, and therefore require frequent replacement. Such systems are therefore not suitable for most vehicular applications where extended usage and durability are required.

There remains a need for a system for generating hydrogen and oxygen gas on demand that does not require storage of significant quantities hydrogen, but that can operate for extended periods of time.

### SUMMARY OF THE INVENTION

The present invention is directed to an apparatus and method for producing a combustible gas mixture, such as hydrogen and oxygen, including an electric power source having a plurality of carbon graphite anodes and carbon graphite cathodes disposed in a generally alternating array and disposed in a vessel that is substantially filled with a conductive solution of water and salt. An electric power source is connected to the anodes and the cathodes, producing a current between the anodes and cathodes through the conductive solution. A gas discharge port is provided in the vessel for discharging the gases produced by the current through the conductive solution.

In an embodiment of the invention the carbon graphite anodes and cathodes are cylindrical rods formed of carbon graphite and a binder baked to form the rods. A portion of the rods may be clad with a conductive metal, such as copper.

In an embodiment of the invention, the rods are between 5 and 25 mm in diameter, and preferably about 9.5 mm in diameter.

In the disclosed embodiment, the electrodes extend downwardly from the upper portion of the vessel, most of the way to the bottom of the vessel.

In a further aspect of an embodiment of the invention, the vessel includes an upper plate assembly having first and second bus plates, the first bus plate connected to the carbon graphite anodes, and the second bus plate connected to the carbon graphite cathodes.

In an embodiment of the disclosed method, carbon graphite electrodes are disposed in a vessel containing a solution of water, substantially immersing the electrodes, and wherein at least one of the carbon graphite cathodes is disposed between at least two carbon graphite anodes, and applying an electric potential across the plurality of carbon graphite anodes and the plurality of carbon graphite cathodes sufficient to cause some of the water in the solution of water and salt to dissociate into hydrogen and oxygen.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a perspective view of a hydrogen and oxygen gas generator according to a first embodiment of the present invention;

FIG. 2 shows an exploded view of the gas generator shown in FIG. 1;

FIG. 3 shows a fragmentary, partially exploded view of the upper plate assembly of the gas generator shown in FIG. 1;

FIG. 4A shows a plan view of the first bus plate for the gas generator of FIG. 1;

FIG. 4B shows a perspective view of the first and second bus plates, showing the relative alignment of the apertures therein;

FIG. 5 shows a cross-sectional view of the gas generator shown in FIG. 1, taken through a vertical plane intersecting a row of electrodes;

FIG. 6 is a schematic representation of the gas generator of FIG. 1, set up as a stand-alone unit to provide hydrogen and oxygen gas;

FIG. 7 shows the gas generator of FIG. 1, showing a vehicular application for the gas generator shown in FIG. 1; and

FIG. 8 is a schematic showing the major elements of the vehicular application shown in FIG. 7.

### DETAILED DESCRIPTION OF THE PREFERRED EMBODIMENT

A currently preferred embodiment of a hydrogen and oxygen gas generator, according to the present invention, will now be described with reference to the figures, wherein like numbers indicate like parts, to teach persons of skill in the art one apparatus for practicing the present invention. Although the currently preferred embodiment is described in some detail, this embodiment is intended to be exemplary, and it will be immediately apparent to persons of skill in the art that many changes and modifications to the preferred embodiment can be made without departing form the spirit and scope of the present invention.

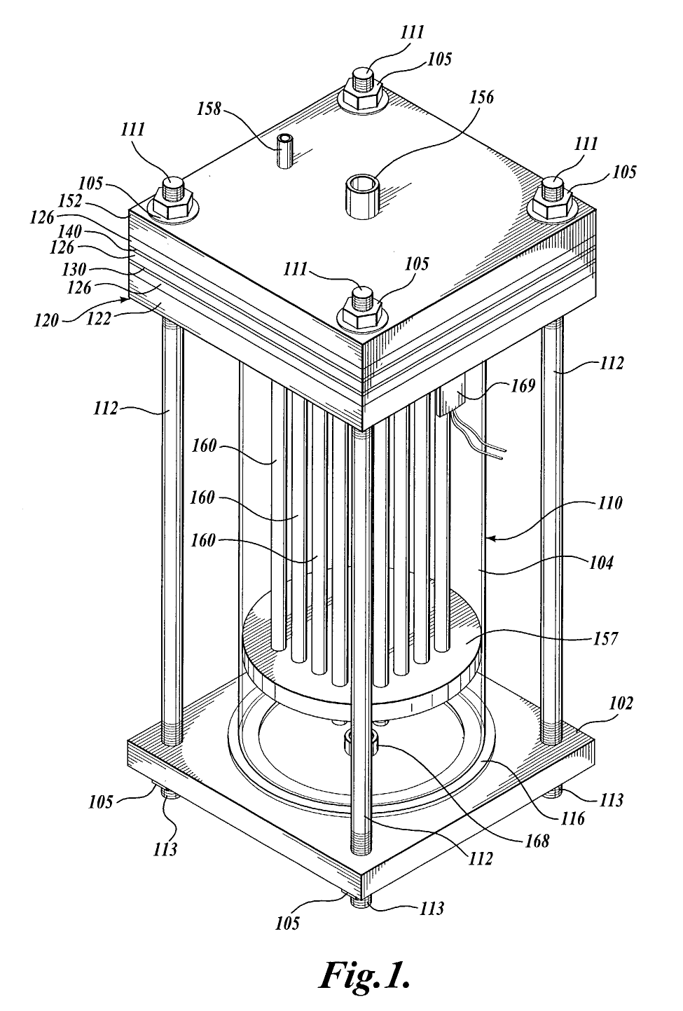

FIG. 1 shows a perspective view of a hydrogen and oxygen gas generator 100, including a base plate 102, a generally cylindrical tubular wall 104, and an upper plate assembly 120. In the present embodiment, the base plate 102 and wall 104 are made from a transparent resin, such as Plexiglas®, although other materials may alternatively be used—including, for example, an extruded aluminum vessel with a nonconductive liner. At least the inner surface of the base plate 102, the wall 104, and upper plate assembly 120 should be nonmetallic. The clear plastic material of the current embodiment advantageously permits the user to view the generation of gas bubbles by the gas generator 100.

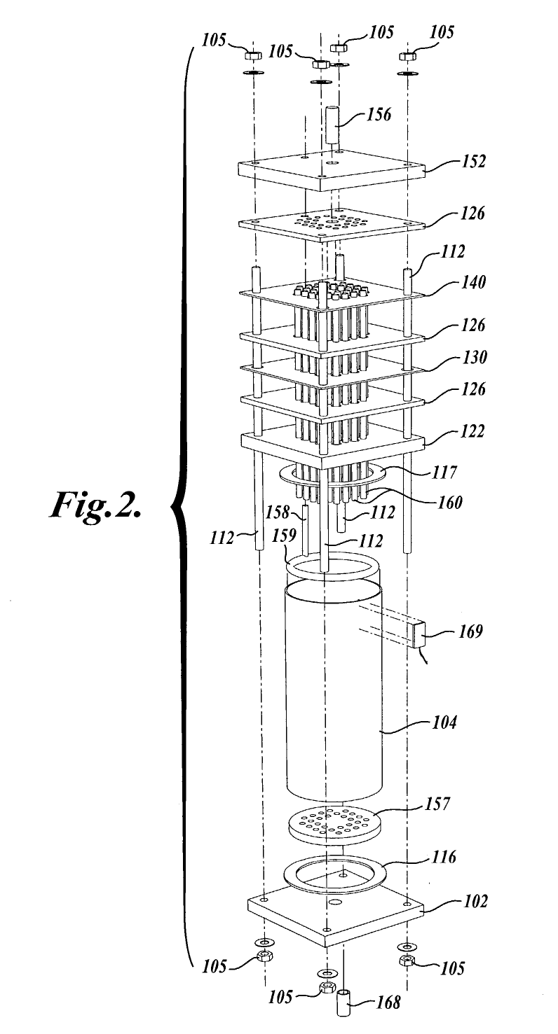

As shown in FIG. 1 and the exploded view in FIG. 2, the base plate 102, wall 104, and upper plate assembly 120 cooperatively define a generally cylindrical vessel 110. The vessel 110 is held together with four threaded tie rods 112 disposed near each comer of the gas generator 100, outside of the cylindrical wall 104. The bottom portion 113 of the tie rods 112 extend through apertures 103 in the base plate 102, and the top portion 111 of the tie rods 112 extends through apertures 123 in the upper plate assembly 120. Nuts 105 are provided at both ends of the tie rods 112, whereby the tie rods 112 compressively hold the vessel 110 together. An annular lower compression gasket 116 is provided between the base plate 102 and the wall 104, and a similar annular upper compression gasket 117 is provided between the upper plate assembly 120 and the wall 104, thereby sealing the vessel 110 when the tie rods 112 are tensioned.

Disposed within the vessel 110 is a plurality of electrodes 160 that are supported by, and extend downwardly from, the upper plate assembly 120. In the disclosed embodiment, the electrodes 160 are generally cylindrical rods made of carbon graphite. It has been found that Arcair® DC Gouging Carbon welding rods, distributed by CIGWELD as CIGWELD Part No. 22063003, are suitable for the present invention. These welding rods are 9.5 mm in diameter by 305 mm long, and are made by mixing carbon/graphite with a binder, baking, and then coating with a controlled thickness of copper. The electrodes 160 preferably have a diameter between about 5 mm and about 25 mm. In the present embodiment, the copper coating is removed from most of the length of the electrode 160, leaving the copper in place for the upper portion of the electrodes 160, as discussed below. In the preferred embodiment, the electrodes are arranged in a generally square array, with a center-to-center spacing of approximately 0.6 inch. Other suitable array layouts and spacing may alternatively be used.

The upper plate assembly 120 is generally a multilayer construction including a lower plate 122, an insulating gasket 126, a first bus plate 130, a second insulation gasket 126, a second bus plate 140, and a top plate 152. In the particular embodiment shown in FIGS. 1 and 2, the lower plate 122, insulating gaskets 126, bus plates 130, 140 and the top plate 152 are generally square, flat components stacked one atop the other the upper plate assembly 120. The insulating gaskets 126 may be made from, for example, a rubber gasket material.

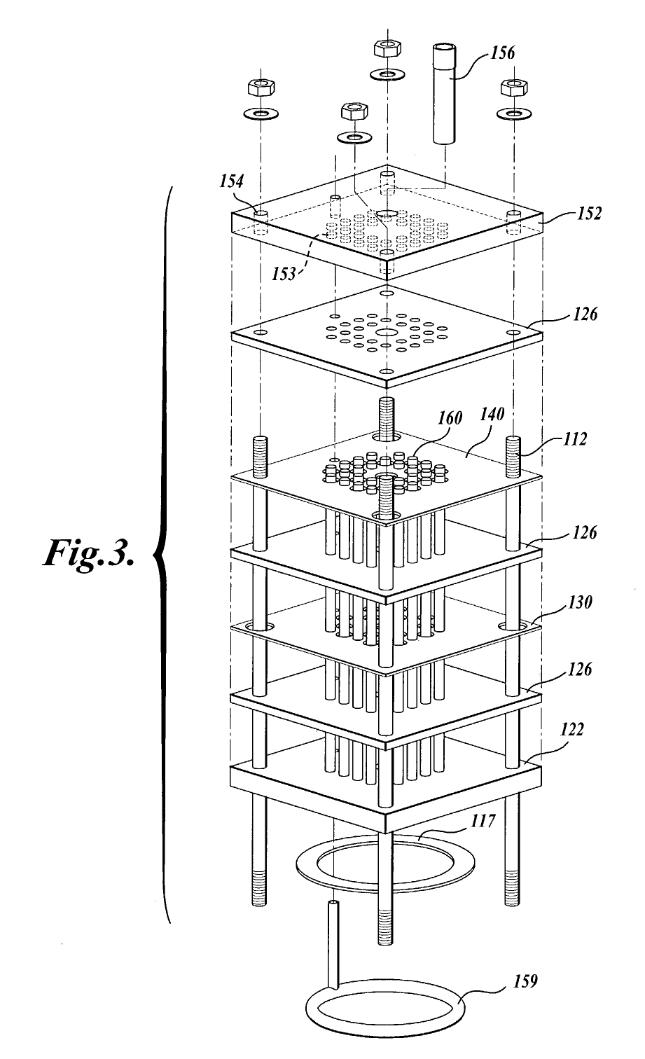

As seen most clearly in the partial exploded view of FIG. 3, the lower plate includes a plurality of apertures 123, which apertures are sized to permit the electrodes 160 to pass therethrough, and apertures 124 in the corners to slidably accommodate the tie rods 112. Both insulating gaskets 126 also have apertures 127 that receive the electrodes 160, and corner apertures 128 that receive the tie rods 112. Similarly, the first bus plate 130 has apertures 133, 133′ and the second bus plate 140 has apertures 143, 143′ that accommodate the electrodes 160, and the first and second bus plates 130 and 140 have corner apertures 134, 134′, 144, 144′ that accommodate the tie rods 112. Finally, the top plate 152 has apertures 153 that extend only part way through the top plate 152, which are sized and positioned to receive the upper ends of the electrodes 160, and corner apertures 154 that accommodate the tie rods 112.

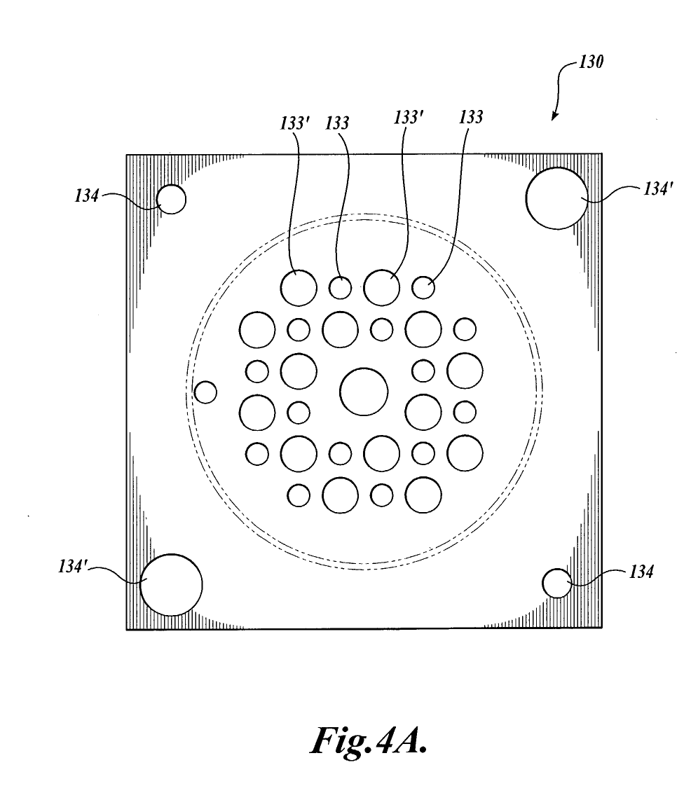

The first and second bus plates 130, 140 are made of a conductive material, such as copper or brass. As seen most clearly in FIG. 4A, which shows a plan view of the first bus plate 130, the electrode apertures include smaller apertures 133 that alternate with larger apertures 133′. In particular, the smaller apertures 133 have a diameter that is very close to the diameter of the electrodes 160. In the disclosed embodiment, the electrodes 160 that pass through the smaller apertures 133 are electrically connected to the first bus plate 130, for example, by solder (not shown). As discussed above, the upper portion of the electrodes 160 has a copper cladding. This copper cladding facilitates obtaining a good electrical connection between the carbon graphite electrodes and the first bus plate 130.

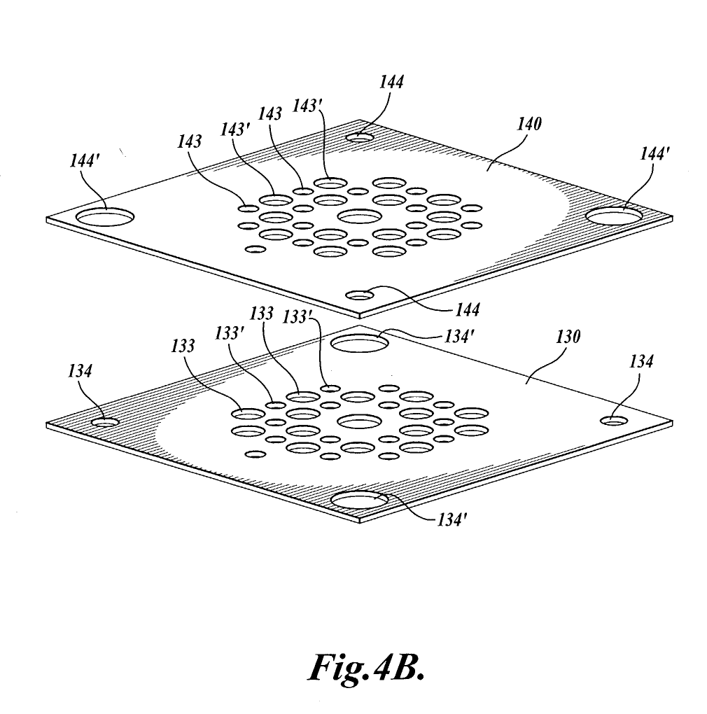

Referring now to FIG. 4B, which shows the first and second bus plates 130, 140 in isolation, the second bus plate 140 is identical to the first bus plate 130. However, the second bus plate 140 is flipped over relative to the first bus plate 130, which results in the smaller apertures 144 being concentrically disposed over the larger apertures 133′ of the first bus plate 130, and the larger apertures 144′ being concentrically disposed over the smaller apertures 133. As seen most clearly in the cross-sectional view of FIG. 5, the alternate electrodes 160 that pass through the larger apertures 133′ of the first bus plate 130 are then electrically connected, for example, by solder, to the second bus plate 140, at the smaller apertures 143′. It will now be appreciated that one set of alternating electrodes 160 is electrically connected to the first bus plate 130, and the remaining electrodes 160 are electrically connected to the second bus plate 140. The insulating gasket 126 is disposed between the first bus plate 130 and the second bus plate 140.

Similarly, on the first bus plate 130, the corner apertures include smaller corner apertures 134 that have approximately the same diameter as the tie rods 112 and larger corner apertures 134′. On the second bus plate 140, larger corner apertures 140′ are disposed over the smaller corner apertures 134 of the first bus plate, and smaller corner apertures 140 are disposed over the larger corner apertures 134′. In this embodiment, one pair of diagonally disposed tie rods 112 is electrically connected to the first bus plate 130 at the smaller corner apertures 134, and the other pair of diagonally disposed tie rods 112 is electrically connected to the second bus plate 140 at the smaller corner apertures 144. The tie rods 112 are preferably electrically conductive. It should now be appreciated that the disclosed configuration facilitates applying an electric potential to the electrodes such that adjacent electrodes are oppositely charged. The positive terminal of the power supply (not shown) is electrically connected to one tie rod 112, and the negative terminal (not shown) is connected to an adjacent tie rod 112, thereby energizing the first bus plate 130, and connected electrodes 160 to one polarity, and the second bus plate 140, and connected electrodes 160, to the other polarity.

Referring again to FIGS. 1 and 2, the upper plate assembly 120 also includes a generally centered gas discharge port 156 that provides a fluid channel out of the vessel 110 and, optionally, a mixing air inlet port 158 that provides a fluid inlet into the vessel 110. An annular mixing air plenum 159 having a plurality of holes (not shown) is disposed inside the vessel 110 near the upper plate assembly 120, and is fluidly connected to the mixing air inlet port 158. When air is forced through the mixing air inlet port 158 into the vessel 110—for example, when a vacuum is applied to the gas discharge port 156—the air enters the vessel 110 in jets from the holes in the mixing air plenum 159 and facilitates the breaking up of bubbles that are formed during operation of the gas generator 100.

In the preferred embodiment, a spacer plate 157 is also provided near the lower end of the electrodes 160. The spacer plate 157, which, in the exemplary embodiment is conveniently be made from a rigid foam or the like, abuts against the wall 104, and includes a plurality of apertures that receive the electrodes 160, providing additional support and maintaining electrode spacing and alignment.

As shown in FIG. 5, the vessel 110 is substantially filled with a conductive water solution, such as a saline solution 165. A suitable saline solution has been found to be a solution of approximately ⅛ tsp. salt per 2000 mL of water. The saline solution is preferably between about 1/16 and 1 tsp. salt per 2000 mL of water. It is contemplated that the gas generator 100 may be made in a variety of sizes and that the amount of water is a design choice relating to the size of the apparatus, the amount of gas desired, etc. A greater concentration of salt, up to a reasonable limit, will generally increase the conductivity of the saline solution 165 and increase the rate of production of hydrogen and oxygen gases. Other suitable salts or bases, although not preferred, may alternatively be used. It will be appreciated that other salts or other substances may alternatively be added to water to produce a suitable conductive water solution.

A water replenish port 168 may be provided, for example, through the base plate 102, to replenish water that is used during the generation of the gases. A device for detecting the water level in the vessel 110 may be used to determine when replenishment of water is needed. In the preferred embodiment, a density meter 169 is attached near the top of the wall 104 to detect when the fluid level has dropped below the monitored level. One suitable density meter has been found to be Truck BC10-QF5, 5-AP6X2. It will be readily apparent that the density meter 169 would allow for automatic water replenishment—for example, by connecting the output of the density meter to a properly controlled pump and water reservoir. It will also be appreciated that the water replenish port 168 may also conveniently be used to remove any settled sediment or other debris that might accumulate in the vessel 110.

In operation, the vessel 110 containing the electrodes 160 is filled with the saline solution 165, leaving an air gap near the top of the vessel 110. Oppositely-charged terminals from a power source (not shown) are electrically connected to adjacent tie rods 112, thereby imposing an electric potential across the first bus plate 130 and the second bus plate 140, as discussed above, which potential is applied to the electrodes 160, with adjacent electrodes 160 having opposite polarity. This causes a current through the saline solution 165, generating hydrogen and oxygen gases at the electrodes 160. The gases float to the top and may be expelled through the gas discharge port 156, if gas generation will naturally produce a gas pressure expelling the gases. It will be appreciated that the gas discharged is a near-stoichiometric mixture of hydrogen and oxygen, which is ideal for combustion.

As currently understood, the performance and the rate of production of hydrogen and oxygen gases in the gas generator will depend on the electrode 160 material, the spacing between electrodes 160, the conductivity of the saline solution 165, the applied voltage/current, the temperature of the solution 165, the pressure, and the exposed surface area of the electrodes 160.

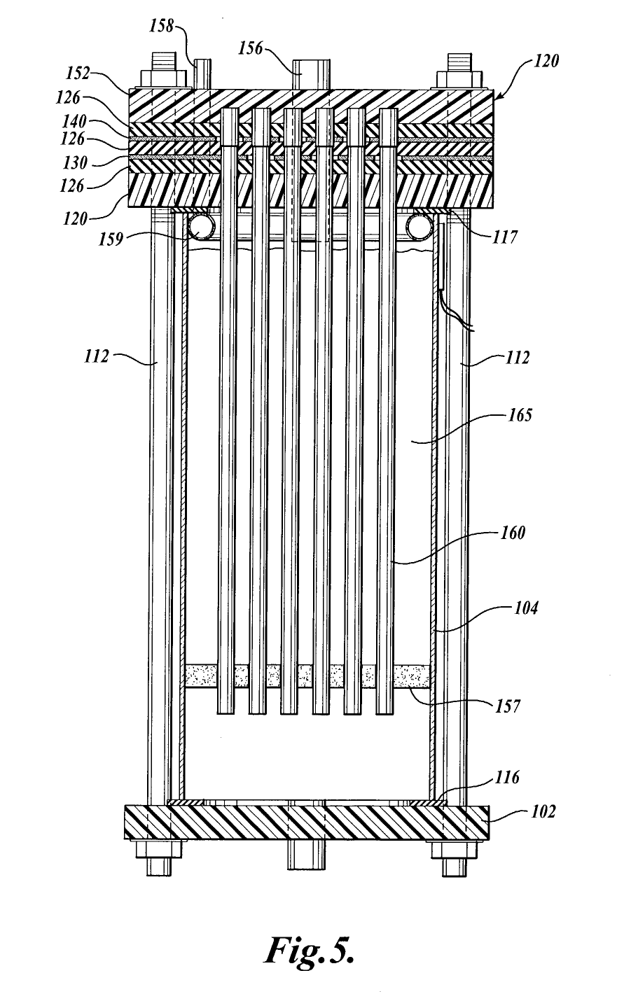

FIG. 6 shows the gas generator 100 set up for a stand-alone application, providing a hydrogen/oxygen gas mixture through a conduit 50 connected to the gas discharge port 156. A power supply 56 is attached to adjacent tie rods 112 with wires 62, 64. A water reservoir 52 is fluidly connected to the water replenishment port 168, and is operable to add make-up water to the vessel 110, as needed. A switch 58 permits a user to start and stop the production of hydrogen and oxygen. In this embodiment, a programmable controller 54 receives inputs 60 from the gas generator 100, such as water level, temperature, and the like, and controls the make-up water and operation of the gas generator 100 based on those inputs. Additional external inputs (not shown) may also be used by the controller—for example, relating to demand for the gas mixture. It is contemplated that the power supply 56 may be controllable, thereby allowing the user to selectively control the rate of production of hydrogen and oxygen. Because the gas generator 100 may produce significant pressures if the gas is not allowed to escape, it is contemplated that a pressure relief valve (not shown) may also be installed on the vessel 110—for example, in the upper plate assembly 120.

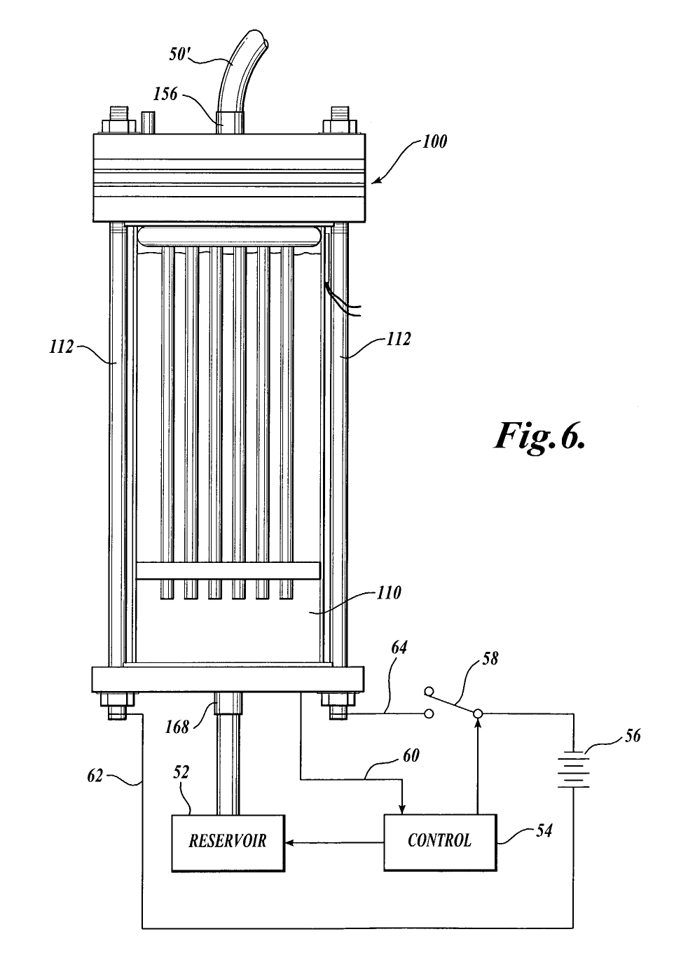

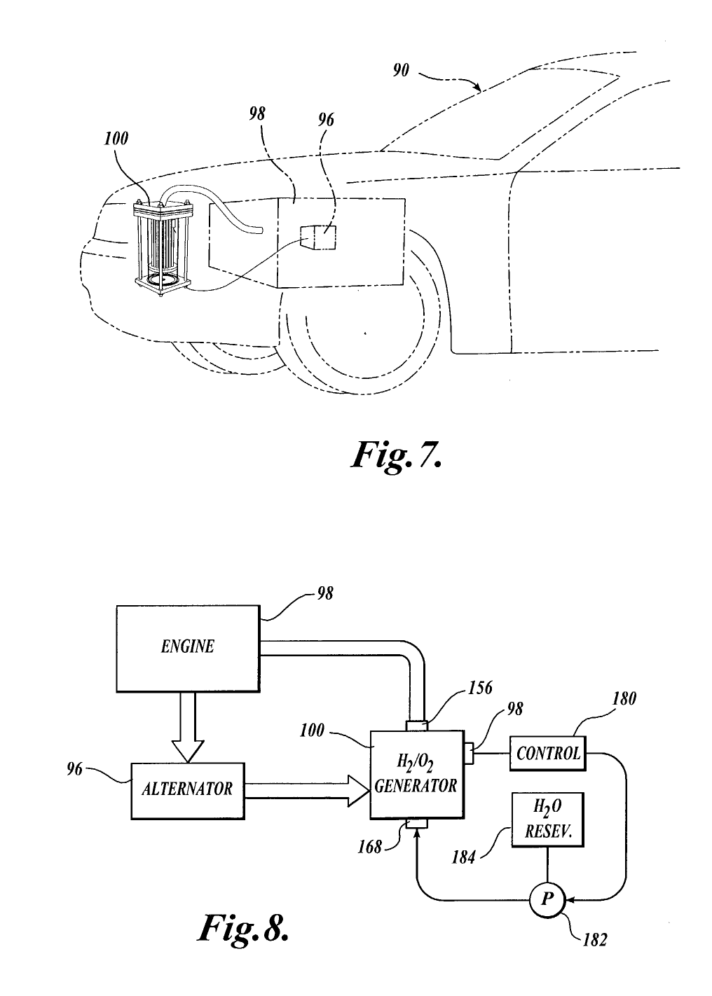

As shown in the sketch of FIG. 7 and the diagram in FIG. 8, one application of the present invention is in automotive applications to improve the efficiency of, for example, a gasoline engine 98. The gas generator 100 is installed in the engine compartment of a vehicle 90. When the engine 98 is operating, the engine alternator 96 provides a DC current to the gas generator 100, causing the gas generator to begin producing a hydrogen and oxygen gas. The gas discharge port 156 is connected to the engine manifold, which generates a vacuum that draws the gas from the gas generator 100 into the engine 98. As discussed above, the hydrogen/oxygen gas mixture improves the efficiency of the combustion of the gasoline in the engine 98. In experiments conducted by the inventor, the improved engine efficiency results in more net work being performed by the engine 98, notwithstanding the additional load required to provide electric power to the gas generator 100. In this embodiment, the density meter 169 detects the water level in the gas generator 100 and signals a controller 180 that controls a pump 182 to provide water to the gas generator 100 from a reservoir 184 through the water replenishment port 168, as needed.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. An apparatus for producing a combustible gas mixture, the apparatus comprising:
an electrical power source having a positive terminal and a negative terminal;
a vessel containing an electrically conductive solution of water and a salt;
a plurality of carbon graphite anodes disposed within the vessel, the carbon graphite anodes electrically connected to the power source positive terminal;
a plurality of carbon graphite cathodes disposed within the vessel, the carbon graphite cathodes electrically connected to the power source negative terminal, wherein at least most of the carbon graphite cathodes are disposed generally between carbon graphite anodes; and
a gas discharge port disposed near a top portion of the vessel.

2. The apparatus of claim 1, wherein the carbon graphite anodes and the carbon graphite cathodes are cylindrical rods.

3. The apparatus of claim 2, wherein the carbon graphite anode and cathode cylindrical rods are between about 5 mm and about 25 mm in diameter.

4. The apparatus of claim 2, wherein the carbon graphite anode and cathode cylindrical rods are about 9.5 mm in diameter.

5. The apparatus of claim 2, wherein the carbon graphite anode and the carbon graphite cathode cylindrical rods are made of carbon graphite baked with a binder, and further comprise a conductive metallic cladding about a portion of the rods.

6. The apparatus of claim 2, wherein the vessel includes an upper plate and a bottom surface, and further, wherein the carbon graphite anode and the carbon graphite cathode cylindrical rods extend downwardly from the upper plate most of the way to the bottom surface.

7. The apparatus of claim 1, wherein the solution of water and salt includes between about 1/16 tsp. salt and about 1 tsp. salt per 2000 mL of water.

8. The apparatus of claim 1, further comprising a sensor for detecting the electrolyte level within the vessel, and wherein the vessel further comprises a water inlet port.

9. The apparatus of claim 8, wherein the sensor is a density meter attached to an outside surface of the vessel.

10. The apparatus of claim 1, wherein the vessel comprises a base plate, a cylindrical wall, and an upper plate assembly, the upper plate assembly having a first bus plate attached to the carbon graphite anodes, a second bus plate attached to the carbon graphite cathodes, and an insulating gasket between the first and second bus plates.

11. The apparatus of claim 10, wherein the upper plate assembly further comprises a gas discharge port and a mixing air inlet port.

12. The apparatus of claim I 1, further comprising replenishing water input port that is adapted to receive water during operation of the gas generator.

13. A hydrogen and oxygen gas generator comprising:
an electrical power supply capable of providing a direct current, the power supply having a positive terminal and a negative terminal;
a vessel having a top portion, a bottom portion, and a side wall connecting the top and bottom portions, the vessel being made from a substantially nonconductive material;
a saline solution substantially filling the vessel;
a plurality of first carbon electrodes, each of the first carbon electrodes being electrically connected to the positive terminal of the electrical power supply, wherein the first carbon electrodes extend downwardly from the top portion of the vessel;
a plurality of second carbon electrodes, each of the second carbon electrodes being electrically connected to the negative terminal of the electrical power supply, the first and second carbon electrodes being disposed in an alternating array wherein first carbon electrodes are generally disposed between at least two second carbon electrodes; and
a gas discharge port disposed in the top portion of the vessel, the gas discharge port adapted to selectively release gas from the vessel.

14. The apparatus of claim 13, wherein the carbon electrodes are cylindrical rods of graphite.

15. The apparatus of claim 14, wherein the electrodes are between about 5 mm and about 25 mm diameter rods.

16. The apparatus of claim 14, wherein the carbon electrodes are about 9.5 mm diameter rods.

17. The apparatus of claim 14, wherein the carbon electrodes are made of carbon graphite baked with a binder, and further comprise a conductive metallic cladding about a portion of the electrodes.

18. The apparatus of claim 13, wherein the saline solution comprises between about 1/16 tsp. salt and about 1 tsp. salt per 2000 mL of water.

19. The apparatus of claim 13, further comprising a sensor for detecting the electrolyte level within the vessel, and wherein the vessel further comprises a water inlet port.

20. The apparatus of claim 19, wherein the sensor is a density meter attached to an outside surface of the sidewall.

21. The apparatus of claim 13, wherein the upper portion of the vessel comprises an upper plate assembly having a first bus plate attached to the first carbon electrodes, a second bus plate attached to the second carbon electrodes, and an insulating gasket between the first and second bus plates.

22. The apparatus of claim 21, wherein the upper plate assembly further comprises a gas discharge port and a mixing air inlet port.

23. The apparatus of claim 22, further comprising a replenishing water input port that is adapted to receive water during operation of the gas generator.

24. A method for generating a mixture of hydrogen and oxygen gas comprising:
substantially immersing a plurality of carbon graphite anodes in a solution of water and salt;
substantially immersing a plurality of carbon graphite cathodes in a saline solution such that at least one carbon graphite cathode is disposed between two carbon graphite anodes; and
applying an electric potential across the plurality of carbon graphite anodes and the plurality of carbon graphite cathodes sufficient to cause some of the water in the solution of water and salt to dissociate into hydrogen and oxygen.

25. The method of claim 24, wherein the carbon graphite anodes and the carbon graphite cathodes are cylindrical rods.

26. The method of claim 25, wherein the cylindrical rods are made of a mixture of graphite and a binder baked together.

27. The method of claim 25, wherein the cylindrical rods are between about 5 mm and about 25 mm in diameter.

28. The method of claim 25, wherein the solution of water and salt includes between about 1/16 tsp. salt and about 1 tsp. salt per 2000 mL of water.
